(19) United States
(12) Patent Application Publication
(10) Pub. No.: US 2026/0292869 A1
(43) Pub. Date: Sep. 24, 2026

(54) METHODS, ARCHITECTURES, APPARATUSES AND SYSTEMS FOR TRACING CAMPED TERMINALS

(71) Applicant: InterDigital Patent Holdings, Inc., Wilmington, DE (US)

(72) Inventors: Faris Alfarhan, Montreal (CA); Oumer Teyeb, Montreal (CA); Paul Marinier, Brossard (CA); Brian Martin, Farnham (GB); Umer Salim, Vallauris (FR)

(21) Appl. No.: 19/474,534

(22) PCT Filed: Apr. 11, 2024
(86) PCT No.: PCT/US2024/023980

§ 371 Date: Oct. 10, 2025

(30) Foreign Application Priority Data
Apr. 11, 2023 (EP) 23305536.7

(51) Int. Cl. H04W 74/00; H04W 24/08; H04W 74/0833

(52) U.S. Cl. CPC H04W 74/004; H04W 24/08; H04W 74/0833

(57) ABSTRACT

Procedures, methods, architectures, apparatuses, systems, devices, and computer program products for tracing camped terminals, i.e., wireless communication devices that are present in a wireless communication cell but that do not transmit/receive to/from a network node operating the cell, with an objective to reduce power consumption of the network without reducing its performance. Therefore, a network or network node may send a special request to UEs (User Equipments). Idle, or inactive UEs camping on the cell may respond with a special random access (RA) that they are camping on the cell, and may perform cell-reselection, so that the network node may enter a low-power consumption mode.

### INCORPORATION BY REFERENCE

The content of the following references are incorporated by reference herein in their entirety: TR 38.864, “Study on network energy savings for NR (Release 18)”; RP-223540, “New WID: Network energy savings for NR”, Huawei; TS 36.927 “Potential solutions for energy saving for E-UTRAN”; TS 36.887 “Study on energy saving enhancement for E-UTRAN”; TR 38.840, “Study on UE power saving in NR”; TS 38.304 “UE procedures in Idle mode and RRC Inactive state”; and TS 38.331 “Radio Resource Control protocol specification”.

### CROSS-REFERENCE TO RELATED APPLICATIONS

This application claims the benefit of European Patent Application No. 23305536.7 filed 11 Apr. 2023, which is incorporated herein by reference in its entirety.

### BACKGROUND

The present disclosure is generally directed to the fields of communications, software and encoding, including, for example, to methods, architectures, apparatuses, systems related to network energy saving (NES) in New Radio (NR) networks.

### SUMMARY

3GPP RAN (Radio Access Network) has concluded a study item on network energy savings for release 18 (Rel-18). The motivation is to study enhancements enabling the network to minimize its power consumption from transmission and reception. Such minimization is beneficial for reducing operational costs and environmental sustainability. The study item was approved and resulted in a new Rel-18 work item on network energy saving.

Compared to earlier systems, the design of NR of Rel-15 is very efficient from the perspective of minimizing transmissions from the network when there is no data. For example, always-on cell-specific reference signal (CRS) is not used in NR. However, there is still potential for further energy consumption reduction.

Embodiments are disclosed, described and claimed in the appended claims, which embodiments that contribute to further network energy saving in New Radio networks.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a flow chart of a method according to an embodiment.

FIG. 3 is a flow chart according to an embodiment; and

FIG. 4 is a flow chart of a method 400 according to an embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Abbreviations and Acronyms

ACK Acknowledgement
BLER Block Error Rate
BWP Bandwidth Part
BFD Beam Failure Detection
CAP Channel Access Priority
CAPC Channel access priority class
CCA Clear Channel Assessment
C-DRX Connected mode discontinuous reception
CE Control Element
CG Configured grant or cell group
CP Cyclic Prefix
CP-OFDM Conventional OFDM (relying on cyclic prefix)
CQI Channel Quality Indicator
CRC Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
DRX Discontinuous reception
DTX Discontinuous transmission
gNB gNodeB/network node; radio base station in 5G NR network
HARQ Hybrid Automatic Repeat Request
LAA License Assisted Access
LBT Listen-Before-Talk
LTE Long Term Evolution e.g., from 3GPP LTE R8 and up
NACK Negative ACK
NES Network Energy Saving
MCS Modulation and Coding Scheme
MIB Master Information Block
MIMO Multiple Input Multiple Output
NR New Radio
OFDM Orthogonal Frequency-Division Multiplexing
PHY Physical Layer
PID Process ID
PEI Paging Early Indication
PO Paging Occasion
PRACH Physical Random Access Channel
PSS Primary Synchronization Signal
RA Random Access (or procedure)
RACH Random Access Channel
RAR Random Access Response
RCU Radio access network Central Unit
RF Radio Front end
RLF Radio Link Failure
RLM Radio Link Monitoring
RMSI Remaining system information
RNTI Radio Network Identifier
RO RACH occasion
RRC Radio Resource Control
RRM Radio Resource Management
RS Reference Signal
RSRP Reference Signal Received Power
RSSI Received Signal Strength Indicator
SDU Service Data Unit
SI System Information
SIB System Information Block
SRS Sounding Reference Signal
SS Synchronization Signal
SSB Synchronization signal block
SSS Secondary Synchronization Signal
SWG Switching Gap (in a self-contained subframe)
SPS Semi-persistent scheduling
SUL Supplemental Uplink
SN Secondary node
TB Transport Block
TBS Transport Block Size
TRP Transmission/Reception Point
TSC Time-sensitive communications
TSN Time-sensitive networking
UCI Uplink Control Information
UL Uplink

### Example Communications System

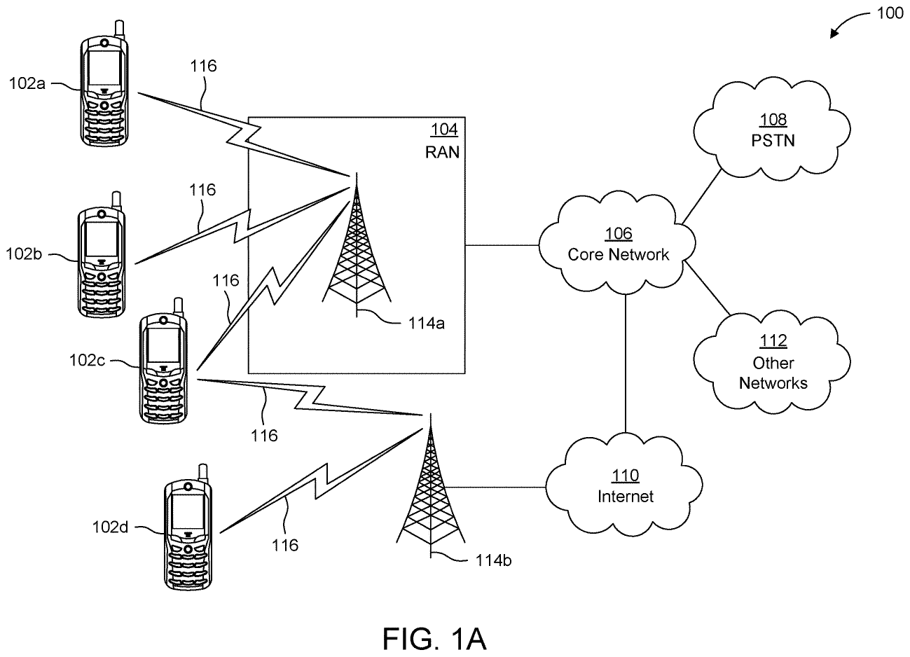

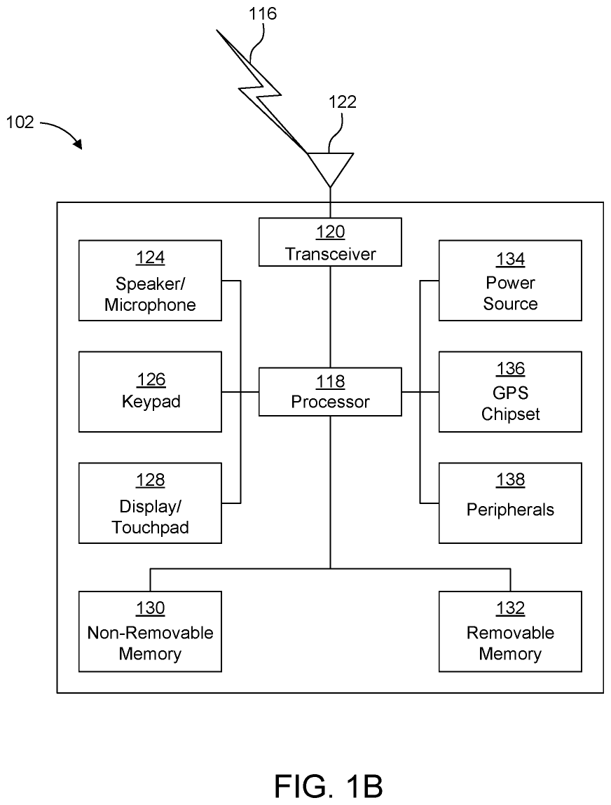

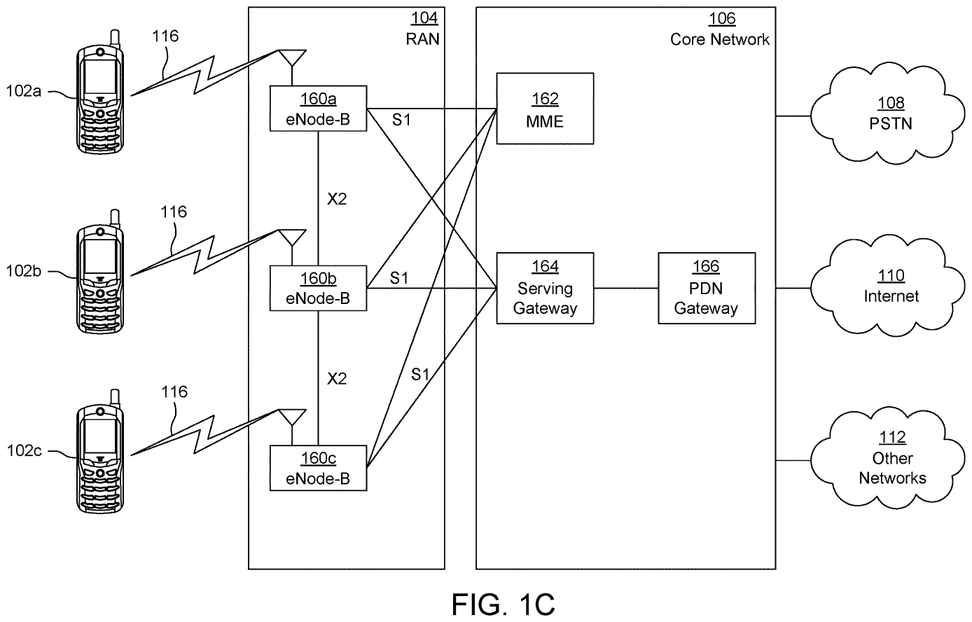

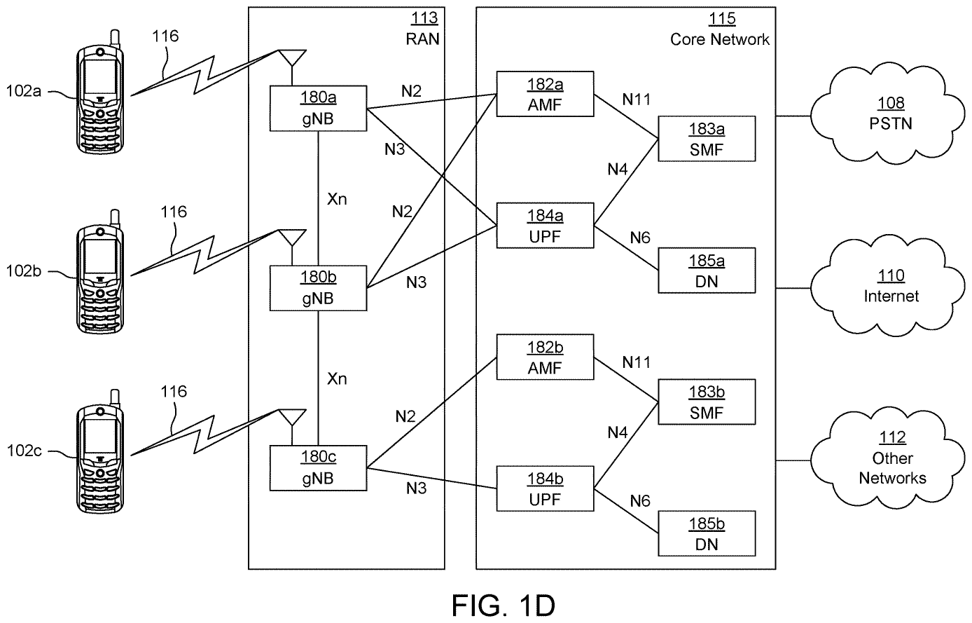

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### INTRODUCTION

As mentioned in the background section, there is still potential for further energy consumption reduction in NR wireless networks, to support reducing operational costs and environmental sustainability.

For example, the network still consumes energy when not transmitting from other activities such as baseband (digital) processing for reception or beamforming. Such “idle” power consumption is not negligible in dense networks even when no WTRU is served during a given period. If the network could turn off these activities when not transmitting to a WTRU, energy consumption could be reduced.

Unlike LTE, NR does not require transmission of always-on synch or reference signals and supports adaptable bandwidth and MIMO capabilities. While initial work in R18 is expected to not impact legacy WTRUs, it's anticipated that such adaptation of network resources will enable greater efficiency in operating newer deployments and later generations.

### Overview

### Terminology

The following terminology is used and can be assumed through this disclosure:

CSI: channel state information, which may include at least one of the following: channel quality index (CQI), rank indicator (RI), precoding matrix index (PMI), an L1 channel measurement (e.g. RSRP such as L1-RSRP, or SINR), CSI-RS resource indicator (CRI), SS/PBCH block resource indicator (SSBRI), layer indicator (LI) and/or any other measurement quantity measured by the WTRU from the configured CSI-RS or SS/PBCH block.

UCI: Uplink control information, which may include: CSI, HARQ feedback for one or more HARQ processes, Scheduling request (SR), Link recovery request (LRR), CG-UCI and/or other control information bits that may be transmitted on the PUCCH or PUSCH.

Channel conditions: any conditions relating to the state of the radio/channel, which may be determined by the WTRU from: a WTRU measurement (e.g., L1/SINR/RSRP, CQI/MCS, channel occupancy, RSSI, power headroom, exposure headroom), L3/mobility-based measurements (e.g. RSRP, RSRQ, s-measure), an RLM state, and/or channel availability in unlicensed spectrum (e.g. whether the channel is occupied based on determination of an LBT procedure or whether the channel is deemed to have experienced a consistent LBT failure). Any measurement as described in section ‘Mobility in RRC_IDLE/RRC_INACTIVE’ or ‘Measurement Gaps’.

PRACH resource: a PRACH resource (e.g., in frequency), a PRACH occasion (RO) (e.g., in time), a preamble format (e.g., in terms of total preamble duration, sequence length, guard time duration and/or in terms of length of cyclic prefix) and/or a certain preamble sequence used for the transmission of a preamble in a random access procedure.

A property of scheduling information (e.g., an uplink grant or a downlink assignment) may consist of at least one of the following: a frequency allocation; An aspect of time allocation, such as a duration; A priority; A modulation and coding scheme; A transport block size; A number of spatial layers; A number of transport blocks to be carried; A TCI state or SRI; A number of repetitions; Whether the grant is a configured grant type 1, type 2 or a dynamic grant.

An indication by DCI, or an indication, may consist of at least one of the following: An explicit indication by a DCI field or by RNTI used to mask CRC of the PDCCH. An implicit indication by a property such as DCI format, DCI size, Coreset or search space, aggregation level, identity of first control channel resource (e.g., index of first CCE) for a DCI, where the mapping between the property and the value may be signaled by RRC or MAC. An explicit indication by a DL MAC CE.

The terms network availability state, cell turned off, cell DTX mode/configuration, or NES state may be used interchangeably. The WTRU may determine a cell DTX/DRX state implicitly from a determined active availability state, and visa-versa.

The term “camp on (/in)” or “camping on (/in)” is used when WTRU behaviors in idle state (e.g., RRC_IDLE) are described. “Camp on” is the WTRU state in which the WTRU stays on a cell and is ready to initiate a potential dedicated service or to receive an ongoing broadcast service. Camping on a cell by the WTRU in the idle state (e.g., RRC_IDLE) has several purposes, such as reception of system information for the camped cell, initiation of an RRC Connection Establishment on the camped cell.

### Network Availability States/Network Energy Saving (NES) States

A WTRU may determine whether it can transmit or receive on certain resources depending on a network availability state, which implies the gNB's power savings status. An availability state may correspond to a network energy savings state, a cell DTX mode, a cell DRX mode, and/or a gNB activity level. An availability state can be uplink or downlink specific, and may change from symbol to symbol, slot to slot, frame to frame, or on longer duration granularity. The availability state may be determined by the WTRU or indicated by the network. An availability state can be, for example, “On”, “DL and UL active”, “UL only active”, “off”, “reduced Tx power”, “dormant”, “micro sleep”, “light sleep”, or “deep sleep”. Such states can be abstracted by NW configuration parameters and/or values, and dynamic indication may point to the active availability state (e.g., by DCI or MAC CE signalling). The “Off” availability state may imply that the gNB's baseband hardware is completely turned off. The “sleep” availability state may imply that the gNB wakes up periodically to transmit certain signals (e.g., presence signals, synchronization, or reference signals) or receive certain UL signals. In some availability states, some DL or UL resources are not available during certain periods of time, and this enables the network to turn off baseband processing and other activities. For example, the WTRU may be configured by RRC with periodic Active and Inactive periods per availability. Some measurement resources (e.g., SSBs or CSI-RS) may only be made available in certain availability states, including: RLM, BFD, RRM measurements, CSI-RS feedback configuration, and/or a different power offset for CSI feedback.

Under certain conditions, the WTRU may further transmit a request to the network (wake-up request) to modify the availability state to a state for which resources that would satisfy WTRU requirements are available.

The WTRU determines an availability state from reception of availability state indication from e.g., by L1/L2 signalling (e.g., a group common DCI or indication), or implicitly determine it from the reception of periodic DL signalling- or lack thereof-.

The WTRU determines if a resource is available for transmission/reception and/or measurements for the determined network availability state if it is applicable in the active availability state. In addition, the WTRU may also adapt its active C-DRX cycle, active spatial elements (e.g., antenna or logical ports), active TRPs, paging occasions as a function of the signaled or determined availability state. The WTRU may be configured with one or more sets of NES transmission and/or reception parameters per availability state, e.g., by broadcast or dedicated configuration signalling. The WTRU may apply the NES parameter set according to the determined or signaled availability state. The WTRU may apply one or more applicable configurations depending on the determined NES state. A set of NES parameter may include: a number of antenna ports, a C-DRX configuration, a measurement configuration (e.g., for RRM, RLM, and/or BFD), CSI feedback, a CSI-RS configuration, an SSB configuration, CHO or mobility candidates, a set of active TRPs.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, or a range of frequencies within a bandwidth part. For example, when an NES state changes in a cell, the WTRU may receive an availability state change indication indicating that this change is just for that cell, for all cells at the same frequency, or/and same RAT.

The WTRU may consider the active availability state associated with a cell, carrier, TRP, or frequency band to be “Off”, “Deep sleep”, or “Micro sleep” after reception of a DL signaling that changes the cell's or TRP's availability state. For example, the WTRU may receive a turn off command on broadcast signaling, RRC signaling, DCI (e.g., a group common DCI), or a DL MAC CE (e.g., indication part of PDSCH). The WTRU may determine an availability state from reception of availability state indication from e.g., by L1/L2 signalling (e.g., a group common DCI or indication) or broadcast signalling associated with an availability state. For example:
a) an availability state change indication could also be part of SI update or SIB signalling (e.g., in a separate SIB that is not read by legacy WTRUs). There can be a common time for all WTRUs in the cell to determine availability state status;
b) the WTRU may determine a change of NES state change from the reception of a group common command L1 signaling (e.g., a group common DCI, a multi-stage DCI, a specific DCI format, or a DCI scrambled by a configured or specified NES-specific RNTI). L1 signaling may indicate one of the configured NES parameters sets to apply, or may determine a delta configuration from the current set of parameters upon determining an NES state change. The WTRU may transmit feedback/acknowledgment to gNB, possibly multiplexed with UL data (e.g., part of an UL TB as a MAC CE or a subheader indication), following the reception of NES state change indication;
c) the WTRU may determine a change of NES state change from the reception of broadcast signaling associated with NES state indication or change, including signaling in SIB(s) or part of a broadcast or multicast PDSCH. The WTRU may be indicated the NES state explicitly in the SIB. The WTRU may be configured with one or more SIBs exclusively associated with configuration of NES parameters. The WTRU may be configured to receive such broadcast or multicast indication periodically; the WTRU may determine an indication is mis-detected if not received on expected periodic occasions, if a number of misdetections is counted, and/or if a timer has elapsed since the last reception of the NES state indication. The WTRU may start inter-cell, inter-frequency, and/or inter-RAT measurements, start a mobility procedure, and/or start evaluating configured CHO candidates following the determination of a misdetection of the NES state indication.

The WTRU may implicitly assume a certain availability state associated with a cell, carrier, TRP, or frequency band (e.g., “Off, “deep sleep”, “micro sleep” or dormant”) from at least one of the following:
a) reception of a command or signal indicating a change in availability state: e.g., a group common DCI in connected mode or RRC signaling or a presence signal. The WTRU may determine an availability state implicitly from the reception of periodic DL signaling. The WTRU may be configured or specified to associate an availability state with one or more DL signal type (e.g., SSB, partial SSB, and/or one or more periodicity;
b) reception of a paging message, paging DCI, paging PDSCH, or a paging related signal (e.g., PEI), possibly on a subset of POs (e.g., those aligned with NES DRX cycle or a configured subset of PDCCH resources). The WTRU may assume a certain availability state after reception of an indication part of the DCI or PDCCH scheduling paging (e.g., as a function of the P-RNTI, NES-RNTI or based on receiving an explicit indication—e.g., on a reserved bit). The WTRU may assume a certain availability state after the reception of a paging message with a certain P-RNTI, a separately configured NES P-RNTI, or the NES group RNTI. The WTRU may assume a certain availability state after the reception of a paging message with a certain P-RNTI. The WTRU may be configured with one more PEI subgroup for NES, where a subgroup may be associated with one or more availability state. The WTRU may assume a certain availability state after reception of a PEI with an NES subgroup, possibly if that subgroup is configured and/or associated with the availability state. The indication of the availability state or the availability state switch may be indicated in the paging payload, e.g., as a flag part of the paging message or the short message. Such paging indication may further indicate an alternative cell to monitor paging on while the cell from which the signaling was received is off, sleep, or in NES state. Such paging indication may further indicate or signal applicable reconfiguration parameters (e.g., for initial access, applicable PRACH resources, applicable SSB/RS occasions, applicable SI cycle, and/or the applicable cell(s) and associated availability states);
c) the gNB DTX status (whether the gNB is in active time or an associated activity timer is running);
d) a lack of detection of a presence indication;
d1) as an example of a lack of detection of a presence indication, a WTRU may determine an availability state associated with the cell (e.g., “off” or “deep sleep”) if presence indication was not detected on one or more presence indication occasion.
d2) as another example of a lack of detection of a presence indication, the WTRU may assume or change the cell's availability state after a number of consecutive misdetections or after timer expires following no detection of a presence signal. The WTRU may determine an availability state is active or de-active after expiry of a timer associated with the availability state. Such timer can be configured and/or maintained in connected mode only, or also in other states (e.g., idle and inactive states).
d3) as another example of a lack of detection of a presence indication, a WTRU may determine an availability state implicitly from the lack of reception of periodic DL signaling. For example, the WTRU may be configured with a signal quality threshold (e.g., an RSRP threshold) and if the WTRU does not detect a signal associated with an availability state (e.g., a presence signal or an SSB) with a signal strength above the threshold, the WTRU may assume that this availability state is not active and may assume a different availability state. This criterion can be also coupled with lack of detection of an identifying sequence of the presence signal (e.g., detection of the PSS sequence for example).
e) based on time in the day: a WTRU may be configured to automatically assume a certain availability state (e.g., off, sleep, or dormant) for a configured subset of cells (e.g., capacity boosting cells) depending on the time in the day. For example, the WTRU may determine that a capacity boosting cell has an availability state as “On” in certain hours of the day, “Deep sleep” in other configured hours, and “Off” in a third set of configured hours of the day or night;
f) based on the availability state of an associated cell (e.g., another carrier of the same MAC entity, another carrier in the same cell group, another carrier in the same gNB, another sector in the same gNB, or a configured associated cell or capacity boosting cell);
g) detection of a PSS only signal or a simplified/stripped down SSB signal;
h) detection of an RS signal (e.g., CSI-RS, PRS, TRS) or the lack thereof;
i) the WTRU's (RRC) state (e.g., idle, inactive, or connected);
j) whether paging has been received, possibly within a configured time window;
k) whether system information (e.g., periodic SI or a subset of SIBs) have been received, possibly within a configured time window;
l) measured channel condition(s) being below- or above-a threshold. The WTRU may assume a change of NES state based on a change of measured channel conditions or making a channel measurement below—or above—a threshold. For example, the WTRU may use degradation in measurements of SSBs or CSI-RS, possibly in combination with other signaling—to determine the NES state. For example, a configured window following the DCI reception can be used to measure SSBs and/or CSI-RS for degradation, and if a delta of SSB-RSRP drop is measured the WTRU may determine that the NES state has changed and assume associated actions for such NES state (e.g., trigger for CHO candidate selection or for group scheduling for a mobility command).

The WTRU may be configured to monitor an indication that may characterize the level of network activity (e.g., an availability state). The network activity may be associated with a gNB and/or a cell. The WTRU may assume the same availability state for all cells part of the same gNB, e.g., cells of the same MAC entity. The network activity indication (e.g., the presence indication) may consist of a channel (e.g., a PDCCH) and/or a signal (e.g., a sequence). The activity indication or the NES state change indication/command may indicate the level of activity the WTRU may expect from the associated gNB and/or cell, e.g., reduced activity. The activity indication may contain activity information of other gNBs/cells. The activity indication may be a PDCCH containing group common signaling. For example, the NW may transmit a group common DCI to a group of WTRUs (e.g., WTRUs in the serving cell) indicating a change of an activity state or activity level in UL and/or DL. The CRC of the PDCCH may be scrambled with a dedicated “activity indication RNTI or an NES-RNTI”. A WTRU may be configured with at least one search space associated with the monitoring occasions of the activity indication PDCCH. The indication may consist of a go-to-sleep signal, e.g., a predefined sequence. When WTRU detects this sequence, WTRU may expect a reduced activity level over a specific time duration. The WTRU may activate C-DRX for the period of time indicated. Alternatively, two sequences may be used to indicate regular activity and reduced activity.

The signaling within the PDCCH or the activity indication may contain at least one of the following:
a) expected activity level of the associated gNBs/cells over a specific time interval (e.g., an availability state). The activity levels may be predetermined and/or configured and may, for example, consist of regular and reduced activity. The signaling may indicate the activity level. For example, bit “1” may indicate regular activity and bit “0” may indicate reduced activity;
b) for each activity level (e.g., availability state), transmission and reception attributes may be defined. For example, during reduced activity, WTRU may not be expected to monitor certain PDCCH search spaces (including all SSs), and/or receive a certain type of PDSCH (including all PDSCH), and/or transmit PUCCH/PUSCH, and/or perform certain measurements. The WTRU may start or stop monitoring PDCCH and/or TCI states associated with determined NES state, including PDCCH resources or TCI states associated with (de) activated TRPs or spatial elements;
c) a set of configurations may be associated with an activity level and may be used/applied when that activity level is indicated (e.g. an NES parameter set). For example, SS configurations, CSI reporting configurations, indices of transmitted SSBs, etc. Each set of configurations may have an attribute associated with an activity level. For example, a tag that can be set to “reduced activity”;
d) the time interval over which an activity level is assumed may be signaled in the PDCCH or part of the activity indication;
d1) as an example of the time interval over which an activity level is assumed may be signaled in the PDCCH or part of the activity indication, the time interval may be indicated using a bitmap where each bit in the bitmap may be associated with a specific duration, e.g., a slot or a frame. For example, bit “1” may indicate regular activity and bit “0” may indicate reduced activity on an associated frame;
d2) as a further example of the time interval over which an activity level is assumed may be signaled in the PDCCH or part of the activity indication, the time interval may be indicated with a start time and length of interval. The start time may be defined; for example, it may be determined by adding a fixed offset to the time the indication is received. The length of the interval may be configured or signaled in the indication PDCCH.
d3) the time interval over which an activity level is assumed may be predetermined. The WTRU may assume an interruption delay (or more generally a time till the NES state changes) after the NES state change command reception (e.g., after the last symbol or slot on which the command was received). The interruption time can be in absolute time, a number of symbols, or a number of slots.

The WTRU may determine that an uplink or downlink resource or signal is available for transmission/reception and/or measurements for the determined network availability state if it is applicable in the active availability state. The WTRU may determine that a subset of measurement resources and/or signals (e.g., SSBs, CSI-RS, TRS, PRS) are not applicable in certain availability states. The WTRU may determine that a subset of uplink or downlink resources (e.g., PRACH, PUSCH, PUCCH) are not applicable in certain availability states. The WTRU may transmit some uplink signals only in a subset of NW availability states (e.g., SRS, pSRS, PRACH, UCI).

### NES Alternative Cells

The WTRU may perform cell (re)-selection, mobility to another serving cell, trigger mobility related measurements, and/or start evaluating CHO candidates on alternate cells upon determining an NES change on the camped cell or the serving cell. The WTRU may be configured or predefined with an alternative serving cell to perform initial access, mobility, or cell reselection on in the event the current serving cell or a capacity boosting cell (e.g., a cell not configured as an alternative cell) is turned off or a certain condition is met. The WTRU may be configured per broadcast or dedicated signaling with a list of fallback or alternative serving cells, possible per serving cell, per gNB, per PLMN, or per network identity.

For example, the WTRU may initiate a cell reselection or mobility procedure to an alternative serving cell associated with a cell or gNB from which a turn-off indication was received. In one example, the turn off or go-to-sleep indication may dynamically indicate to the WTRU which cell to fallback or connect to, e.g., by dedicated or broadcast signaling. The fallback/alternative cell can be configured or predefined to be a cell within the same gNB from which a sector has entered NES state (e.g., off, sleep, or reduced power). In another example, the fallback cell may be predefined as the master node cell if the WTRU is in dual connectivity. The fallback/alternative cell can be configured or predefined to be a cell associated with a different RAT or frequency band. For example, the WTRU may fallback to an LTE or an FR1 cell associated with the cell or gNB from which the turn off indication was received (e.g. if the WTRU is in CA or DC using multiple RATs or multiple frequency bands).

The terms alternative cell and stable cell may be used interchangeable in this disclosure. The WTRU may be configured with a list of stable cells (e.g., alternative cells that will not turn off, e.g., some macro cells); the list can be either a list of alternative cells per serving/camped cell or a general list of PCIs for the whole NW, Tracking area, etc. The WTRU may be configured with measurement object configuration for the alternative cells. Alternative cells can be preconfigured to be CHO candidates, potentially considered as CHO candidates only if the source cell turns off/activates NES.

### Mobility in RRC_IDLE/RRC_INACTIVE

### Mobility in RRC_IDLE/RRC_INACTIVE: Cell Selection

The WTRU searches the NR frequency bands and for each carrier frequency identifies the strongest cell as per the CD-SSB. It then reads cell system information broadcast to identify its PLMN(s) to find a suitable cell to camp on. A suitable cell is one for which the measured cell attributes satisfy the cell selection criteria; the cell PLMN is the selected PLMN, registered or an equivalent PLMN; the cell is not barred or reserved and the cell is not part of a tracking area which is in the list of “forbidden tracking areas for roaming”.

On transition from RRC_CONNECTED to RRC_INACTIVE or RRC_IDLE, a WTRU should camp on a cell as result of cell selection according to the frequency be assigned by RRC in the state transition message if any.

The cell selection criterion (known as criterion S) is fulfilled where:

$$Srxlev > 0 AND Squal > 0$$

where:

$$Srxlev = Qrxlevmeas - ( Qrxlev min + Qrxlev min offset ) - Pcompensation - Qoffsettemp$$

$$Squal = Qqualmeas - ( Qqual min + Qqual min offset ) - Qoffsettemp$$

where:
Srxlev=Cell selection RX level value (dB);
Squal=Cell selection quality value (dB);
Qoffsettemp=Offset temporarily applied to a cell (dB);
Qrxlevmeas=Measured cell RX level value (RSRP);
Qrxlevmin=Minimum required RX level in the cell (dBm). If the WTRU supports SUL frequency for this cell, Qrxlevmin is obtained from q-RxLevMinSUL, if present, in SIB1, SIB2 and SIB4, additionally, if QrxlevminoffsetcellSUL is present in SIB3 and SIB4 for the concerned cell, this cell specific offset is added to the corresponding Qrxlevmin to achieve the required minimum RX level in the concerned cell;
else Qrxlevmin is obtained from q-RxLevMin in SIB1, SIB2 and SIB4, additionally, if Qrxlevminoffsetcell is present in SIB3 and SIB4 for the concerned cell, this cell specific offset is added to the corresponding Qrxlevmin to achieve the required minimum RX level in the concerned cell.

Qqualmin=Minimum required quality level in the cell (dB). Additionally, if Qqualminoffsetcell is signalled for the concerned cell, this cell specific offset is added to achieve the required minimum quality level in the concerned cell.

Qrxlevminoffset=Offset to the signalled Qrxlevmin taken into account in the Srxlev evaluation as a result of a periodic search for a higher priority PLMN while camped normally in a VPLMN.

Pcompensation=For FR1, if the WTRU supports the additionalPmax in the NR-NS-PmaxList, if present, in SIB1, SIB2 and SIB4:

$$max ( PE MAX 1 - PPowerClass , 0 ) - ( min ( PE MAX 2 , PPowerClass ) - min ( PE MAX 1 , PPowerClass ) ) ( dB ) '$$

else: max(PEMAX1−PPowerClass, 0) (dB).
For FR2, Pcompensation is set to 0.
For IAB-MT, Pcompensation is set to 0.

PEMAX1, PEMAX2=Maximum TX power level of a WTRU may use when transmitting on the uplink in the cell (dBm) defined as PEMAX. If WTRU supports SUL frequency for this cell, PEMAX1 and PEMAX2 are obtained from the p-Max for SUL in SIB1 and NR-NS-PmaxList for SUL respectively in SIB1, SIB2 and SIB4, else PEMAX1 and PEMAX2 are obtained from the p-Max and NR-NS-PmaxList respectively in SIB1, SIB2 and SIB4 for normal UL.

PPowerClass=Maximum RF output power of the WTRU (dBm) according to the WTRU power class.

The signaled values Qrxlevminoffset and Qqualminoffset are only applied when a cell is evaluated for cell selection as a result of a periodic search for a higher priority PLMN while camped normally in a VPLMN. During this periodic search for higher priority PLMN, the WTRU may check the S criteria of a cell using parameter values stored from a different cell of this higher priority PLMN.

### Mobility in RRC_IDLE/RRC_INACTIVE: Cell Reselection

A WTRU in RRC_IDLE/RRC_INACTIVE performs cell reselection. The WTRU can perform intra-frequency, inter-frequency or inter-RAT cell re-selection.

The WTRU is configured with priorities among RATs (e.g., prioritize camping on NR over LTE whenever an NR cell is available) or among frequencies within the same RAT (e.g., Fa has highest priority, Fb has medium priority, Fc has lowest priority, etc.,). A neighbor cell list (NCL) can be provided to the WTRU, indicating which neighbor cells (e.g., intra-frequency, inter-frequency, inter-RAT) shall be considered for cell reselection. Allow-lists can be provided to the WTRU, indicating the only neighboring cells that could be considered for re-selection. Exclude-lists can be provided to the WTRU, indicating the neighboring cells that should not be considered for re-selection.

The WTRU will try to camp on a cell operating with the highest priority RAT and with the highest priority frequency. If the serving cell fulfils Srxlev>SIntraSearchP and Squal>SIntraSearchQ, the WTRU may choose not to perform intra-frequency measurements; Otherwise, the WTRU shall perform intra-frequency measurements.

If the serving cell fulfils Srxlev>SnonIntraSearchP and Squal>SnonIntraSearchQ, the WTRU may choose not to perform measurements of NR inter-frequency cells of equal or lower priority, or inter-RAT frequency cells of lower priority;
Otherwise, the WTRU shall perform measurements of NR inter-frequency cells of equal or lower priority, or inter-RAT frequency cells of lower priority.

SIntraSearchP, specifies the Srxlev threshold (in dB) for intra-frequency measurements.

SIntraSearchQ, specifies the Squal threshold (in dB) for intra-frequency measurements.

SnonIntraSearchP, specifies the Srxlev threshold (in dB) for NR inter-frequency and inter-RAT measurements.

SnonIntraSearchQ, specifies the Squal threshold (in dB) for NR inter-frequency and inter-RAT measurements.

When the WTRU decides to perform intra-frequency measurements for cell re-selection based on the criteria above, it will perform the cell rankings of the concerned cells. Inter-frequency and inter-RAT reselection is based on absolute priorities where a WTRU tries to camp on the highest priority frequency available. The cell-ranking criterion (referred to as Criteria R) for serving cell (Rs) and for neighboring cells (Rn) is defined by:

$$Rs = Qmeas , s + Qhyst - Qoffsettemp$$

$$Rn = Qmeas , n - Qoffset - Qoffsettemp$$

where:
Qmeas=RSRP measurement quantity used in cell reselections.

Qoffset=For intra-frequency: Equals to Qoffsets,n, if Qoffsets,n is valid, otherwise this equals to zero.

For inter-frequency: Equals to Qoffsets,n plus Qoffsetfrequency, if Qoffsets,n is valid, otherwise this equals to Qoffsetfrequency.

Qoffsettemp=Offset temporarily applied to a cell.

The WTRU shall perform ranking of all cells that fulfil the cell selection criterion S. The cells shall be ranked according to the R criteria specified above by deriving Qmeas,n and Qmeas,s and calculating the R values using averaged RSRP results. If rangeToBestCell is not configured, the WTRU shall perform cell reselection to the highest ranked cell. If rangeToBestCell is configured, then the WTRU shall perform cell reselection to the cell with the highest number of beams above the threshold (i.e., absThreshSS-BlocksConsolidation) among the cells whose R value is within rangeToBestCell of the R value of the highest ranked cell. If there are multiple such cells, the WTRU shall perform cell reselection to the highest ranked cell among them.

In all cases, the WTRU shall reselect the new cell, only if the following conditions are met:
a) the new cell is better than the serving cell according to the cell reselection criteria specified above during a time interval TreselectionRAT;
b) more than 1 second has elapsed since the WTRU camped on the current serving cell.

### Measurement Gaps

The WTRU needs measurement gaps to perform measurements when it cannot measure the target carrier frequency while simultaneously transmitting/receiving on the serving cell.

In the case of LTE, the WTRU needs measurement gaps to perform inter-frequency and inter-RAT measurements. Typical LTE gap length is 6 ms which accommodates 5 ms measurement time (PSS and SSS are transmitted once every 5 ms) and RF re-tuning time of 0.5 ms before and after the measurement gap. The measurement gap repeats with a periodicity of either 40 ms or 80 ms.

Similarly, in NR, the measurements that the WTRU performs can be gap-assisted (network configures measurement gap) or non-gap-assisted. The need for measurement gap in NR depends on the capability of the WTRU, the active BWP of the WTRU and the current operating frequency.

In NR, measurements gaps might be required for intra-frequency, inter-frequency and inter-RAT measurements. Unlike LTE intra-frequency case, intra-frequency measurements in NR might require a measurement gap in cases for example, if the intra-frequency measurements are to be done outside of the active BWP. Measurement gap lengths of 1.5, 3, 3.5, 4, 5.5, and 6 ms with measurement gap repetition periodicities of 20, 40, 80, and 160 ms are defined in NR.

In NR, the RF re-tuning time is 0.5 ms for carrier frequency measurements in FR1 (Frequency Range 1) and 0.25 ms for FR2 (Frequency Range 2), where FR1 defines bands in the sub-6 GHz spectrum and FR2 defines bands in the mmWave (millimeter wave) spectrum. For example, a gap length of 4 ms for FR1 measurements would allow 3 ms for actual measurements and a gap length of 3.5 ms for FR2 measurements would allow 3 ms for actual measurements.

During the measurement gaps, the measurements are to be performed on SSBs of the neighbor cells. The network provides the timing of neighbor cell SSBs using SS/PBCH Block Measurement Timing Configuration (SMTC).

The measurement gap and SMTC duration are configured such that the WTRU can identify and measure the SSBs within the SMTC window i.e., the SMTC duration should be sufficient to accommodate all SSBs that are being transmitted. For SSB based intra-frequency measurements, the network always configures measurement gap in the case when any of the WTRU configured BWPs do not contain the frequency domain resources of the SSB associated to the initial DL BWP.

For SSB based inter-frequency measurements, the network always configures measurement gap in the following cases:
a) if the WTRU supports per-FR measurement gaps and if the carrier frequency to be measured is in same FR as any of the serving cells;
b) if the WTRU only supports per-WTRU measurement gaps. In this case, the measurement object can be configured on any frequency range (FR1 or FR2) but the gap will anyway be configured by the network.

Inter-RAT measurements in NR are limited to E-UTRA. For a WTRU configured with E-UTRA Inter-RAT measurements, a measurement gap configuration is always provided when:
a) the WTRU only supports per-WTRU measurement gaps; or
b) the WTRU supports per-FR measurement gaps and at least one of the NR serving cells is in FR1.

Depending on the WTRU capability to support independent FR measurement and network preference, there are two types of measurement gaps defined in NR; per-WTRU and per-FR. In per-FR gap, two independent gap patterns (i.e., FR1 gap and FR2 gap) are defined for FR1 and FR2 respectively. Per-WTRU gap applies to both FR1 (E-UTRA and NR) and FR2 (NR) frequencies. The WTRU may be configured with several measurement gap configurations. The main parameters of a measurement gap config are:
a) mgrp (Measurement Gap Repetition Period) is the periodicity (in ms) at which measurement gap repeats. Periodicities of 20, 40, 80, and 160 ms are defined in NR.
b) gapOffset is the gap offset of the gap pattern. Not all 160 offset values applicable for all periodicities. As the offset values points to the starting subframe within the period, its value range is from 0 to mgrp-1. For example, if the periodicity is 40 ms, the offset ranges from 0 to 39.
c) mgl (Measurement Gap Length) is the length of measurement gap in ms. Measurement gap lengths of 1.5, 3, 3.5, 4, 5.5, and 6 ms are defined in NR.
d) mgta (Measurement Gap Timing Advance)—If this is configured, the WTRU starts the measurement mgta ms before the gap subframe occurrence i.e., the measurement gap starts at time mgta ms advanced to the end of the latest subframe occurring immediately before the measurement gap. The amount of timing advance can be 0.25 ms (FR2) or 0.5 ms (FR1).

### Achieving Network Energy Savings

Turning off some cells can achieve network energy savings by reducing the amount of power consumed by the network equipment associated with those cells. By selectively turning off cells that are not heavily utilized or strategically reducing the number of cells in a certain area, the network can operate more efficiently, reducing energy consumption and costs while maintaining adequate coverage and capacity. This can result in significant energy savings over time, reducing the environmental impact of the network and improving its sustainability, especially during times of low demand, e.g., at night.

On problem, however, is that the network is not aware of whether and how many WTRUs are camping in the cell prior to turning it off. Turning cell off with IDLE or Inactive state WTRUs camping on it can therefore result in some WTRUs creating interference when they connect. Further, Those WTRUs may also not be able to be paged if they are in bad coverage.

When a cell is turned off, there is a risk that camping WTRUs may create interference when attempting to reconnect to another cell that remains. Additionally, some of these WTRUs may be in areas with poor coverage and may not be reachable by the network if they are paged after the cell is turned off.

This problem highlights the importance of proper planning and coordination prior to turning off cells in a network. To mitigate the risks associated with turning off a cell with camping WTRUs, the network operator may need to implement measures such as turning off a cell only if there is a limited number of WTRUs, only if the remaining WTRUs can be served reliably by other cells, or by notifying the WTRUs in advance or redirecting them to another cell before turning off the current cell.

### Network Probed Identification of Camped WTRUs

According to an embodiment, of which the details are described in further sections ‘Tracing Random Access Procedure’ and ‘Triggering by Trace Probe Command’, a network may get accurate information on how many WTRUs are currently camping on a cell that might be turned off. Therefore, a WTRU may initiate a special RA (‘tracing RA’) upon reception of a camping probe request.

In a first step, the network sends a camping-probe request (e.g., group paging, an indication in the paging payload/short message, or SIB broadcast, etc.).

In a second step, IDLE/INACTIVE WTRUs camping under that cell from which the camping-probe was received respond, informing the NW they are camping on the cell.

In a sub-step of the second step, these WTRUs initiate RA on the camped cell. Such RA may be a “special” RA in a sense that WTRUs do not expect a RAR, it is just to inform the network that “I am here”. The WTRUs may consider the RA successfully completed without receiving a RAR or Msg4 (i.e., WTRUs may not monitor for RAR after preamble transmission).

A WTRU may be configured with a subset of preambles or ROs to indicate to the NW whether there is a suitable alternative cell or not. If there is an alternative neighbor cell>threshold, WTRU selects preamble partition A, otherwise selects partition B. Partitions A and B are configured in SIB. The WTRU may select the PRACH partition based on {there are no good alternative cell, there is at least one good enough alternative cell, the probed cell is within a single strength threshold, the probed cell is measured less than a threshold}.

A WTRU may apply a random backoff prior to transmit the preamble, to avoid many RACH collisions.

Instead of selecting a partition, the WTRU may indicate in msg3 that it is camped on the probed cell and/or a suitable alternative cell (e.g., in an RRC message or MAC CE).

### Location/Signal Strength-Based Camping Probing

According to a further embodiment, of which the details are described in following sections ‘Tracing Random Access Procedure’, ‘Location-based Trigger’, and ‘Camped Cell Quality-based Trigger’, a network may get accurate information on how many WTRUs are currently camping near the cell center. Therefore, the WTRU initiates a special RA if it is within coverage or location proximity of a reference probing cell.

In a first step, the network sends a camping-probe request (e.g., group paging, an indication in the paging payload/short message, or SIB broadcast, etc.).

WTRUs may be configured with a list of alternative/stable cells.

The camping probe request may include: a reference location info or range (e.g., coordinates of the gNB, co-ordinate range), or a reference signal/SSB to measure, possibly from the same cell or a neighbor cell, or an instruction to measure SSBs/RS of the cell from which the probe was received or an indicated/configured alternative cell, or an indication that the serving cell is about to turn off or apply NES.

In a second step, for a WTRU that is within a certain radius from the indicated reference location, or if a WTRU measures the cell from which the probe was received within a certain signal strength/quality (e.g., above an indicated threshold), or if a WTRU measures a neighbor/alternative cell within a certain signal strength/quality: the WTRU responds with a special RA on the probing cell as described in previous section ‘Network-Probed Identification of Camped WTRUs’.

### WTRU Autonomous Reporting and Triggering of the Special RA

According to a further embodiment, of which the details are described in following sections ‘Tracing Random Access Procedure’ and ‘WTRU Autonomous Trigger based on Neighbor Cell Measurements’, a network may get accurate information on how many WTRUs would experience transmission and/or reception difficulties if the camped cell turns off. Therefore, a WTRU may initiate a special RA if there aren't any good enough neighbor cells (i.e., neighbor cells that would be expected to ensure good or sufficient transmission and/or reception; ‘good’ means that measured channel conditions/quality are above a threshold, such that outage or service discontinuity are avoided), and thus the WTRU would experience difficulties, if the camped cell turns off.

In a first step, a WTRU may receive an indication/configuration, or may determine, that the camped cell is an NES cell, a cell that may be turned off, or a cell that is applying a NES state.

A WTRU may be configured with a list of alternative/stable cells.

In a second step, a WTRU may measure the camped cells and other neighbor cells, possibly only for a limited period. If at least one of the following is satisfied:
a) the {Srxlev, Squal, Qrxlevmeas, Qqualmeas} of the camped cell is above a threshold and/or less than a second threshold;
b) the {Srxlev, Squal, Qrxlevmeas, Qqualmeas} of a neighbor/alternative cell is measured above a threshold and/or less than a second threshold;
c) there are no good alternative cell above a threshold, e.g., based on {Srxlev, Squal, Qrxlevmeas, Qqualmeas} of the neighbor cells;
d) measurements relative to an alternative cell becomes above a threshold after having no good alternative cell (‘good’ refers here to channel conditions, and means that measured channel conditions/quality are above a threshold, such that outage or service discontinuity are avoided).

Then, in a third step, the WTRU may autonomously report to the NW if other cells are not suitable (e.g., the other cells do not offer good channel conditions), and/or the camped cell can turn off/apply NES (e.g., initiate a special RA on the camped cell): the WTRU responds with a RA on the camped cell as described in previous section ‘Network-Probed Identification of Camped WTRUs’. In summary, the WTRU may report, using the special RA, to the NW if other cells are not suitable, and then the camped cell may turn off NES; otherwise the camped call may apply NES (e.g., if no special RA received).

In the following sections, the following terminology may be used:
Tracing RA or Special RA: a random-access procedure initiated through any of the triggers, as described in section ‘Triggers to Initiate Special RA for Camped Cell Reporting’ further on in this document, e.g., by receiving a tracing probe command or indication from the network or initiated autonomously by the WTRU based on neighbor cell measurements (e.g., no alternative cell above a threshold);
Tracing probe indication/command: a command issued by the network to track which cell the WTRU is camped in, the best neighbor or alternative cell, the WTRU location, and/or proximity to the probing cell, as described in further section ‘Triggers to Initiate Special RA for Camped Cell Reporting’.

Probed cell: the cell from which tracing probe indication was received (as described in further section ‘Triggers to Initiate Special RA for Camped Cell Reporting’) or a neighbor/alternative cell that is indicated part of a tracing probe indication.

Channel conditions: defined in previous section ‘Terminology’.

Special RACH access, special RA, tracing RA: a random-access procedure initiated by a WTRU and informing the network the WTRU is camped on the network cell and to which the WTRU does not expect a response (RAR).

### Tracing Random Access Procedure

### Tracing Random Access Procedure—Summary of Steps

Upon initiating a tracing RA, a WTRU informs the NW it is camping on the cell.

In a first step, the WTRU may thus initiate RA on the camped cell. The WTRU may consider the RA successfully completed without receiving a RAR or Msg4 (i.e., the WTRU doesn't monitor for RAR after preamble transmission).

The WTRU may be configured with a subset of preambles or ROs to indicate to the NW whether there is a suitable alternative (neighbor) cell or not. A suitable alternative neighbor cell is a neighbor cell where sufficient channel conditions are expected for the WTRU:
a) if there is an alternative neighbor cell>threshold (e.g., the channel conditions (e.g., measured channel conditions) in the neighbor cell are above a threshold), the WTRU may select preamble partition A; otherwise the WTRU may select partition B. Partitions A and B are configured in SIB;
b) the WTRU may select the PRACH partition based on {there are no good alternative cells, there is at least one good enough alternative cell, the probed cell (defined in section ‘WTRU autonomous reporting and triggering of the special RA’) is within a signal reception strength threshold, the probed cell is measured less than a threshold}. ‘Good’ or ‘good enough’ means in this context that measured channel conditions/quality in the alternative cell are above a threshold, such that outage or service discontinuity may be avoided.

The WTRU may apply a random backoff prior to transmit the preamble, to avoid many RACH collisions.

Instead of selecting a partition, the WTRU may indicate in msg3 that it is camped on the probed cell and/or a suitable alternative cell (e.g., in an RRC message or MAC CE).

### Tracing Random Access Procedure—Tracing RA, an RA Initiated for Reporting to a Camped Cell

Upon satisfying one or more of the triggers in further section ‘Triggers to Initiate Special RA for Camped Cell Reporting’, a WTRU may initiate a random-access procedure to report the camped cell and/or whether there are any alternative cells that meet a quality threshold that can be used by the WTRU for the purpose of paging and initial access. Herein, such RA may be referred to as a Tracing RA or a WTRU tracing RA.

### Tracing Random Access Procedure—Tracing RA, an RA Initiated for Reporting to a Camped Cell: RAR-Less RA

Synopsis: A WTRU may determine whether to monitor or skip RAR depending on a configuration, the PRACH resource selected for the preamble transmission, and/or whether the RA is a tracing RA.

A WTRU may be configured (e.g., in broadcast system information) with whether the WTRU is expected to monitor RAR or MsgB for a tracing RA, possibly per PRACH resource configuration or per cell. Upon initiating a tracing RA, the WTRU may consider the RA procedure successful after transmitting the preamble (msg1) or MsgA transmission, without needing to monitor PDCCH for msg2, msg4, or msgB reception.

A WTRU may apply an offset to the determined transmit power for msg1 or msgA if the WTRU is not expected to monitor RAR for a tracing RA procedure. The offset may be configured by broadcast signaling or predefined, possibly dependent on the WTRU capability, and/or determined based on the WTRU's pathloss estimation. For example, the WTRU may apply a preconfigured or predefined offset A if the pathloss is in a certain configured or predefined range, while applying a different offset B if the pathloss is in a different offset B. The WTRU may determine whether to use an offset and/or which offset value to use based on whether preamble group A or preamble group B is used to transmit msg1.

A WTRU may determine not to partition preambles for msg3 size indication (e.g., group A vs. group B) if the tracing RA is RAR-less, i.e. if the WTRU considers the RA successful without RAR reception.

According to an embodiment, the WTRU may monitor RAR or not depending on whether further indication/information in msg3 or MsgA payload is to be transmitted by the WTRU (e.g., to indicate an alternative cell or whether there is a good enough alternative cell with measured quality above a threshold, or any info described under “tracing indication conditions”). Such can be a function of the PRACH resource used by the WTRU or the preamble partition. The WTRU may determine whether to monitor or skip monitoring RAR, msg4 or msgB as a function of the PRACH resource selected to transmit msg1 or msgA. For example, the WTRU may be configured with a PRACH partition/resource whereby the WTRU is expected to monitor RAR/MsgB after the preamble transmission, and another PRACH partition/resource where the WTRU is not expected to monitor RAR/MsgB following the preamble transmission.

According to an embodiment, for a tracing RA procedure, the WTRU may monitor for msgB or msg2 after msgA/msg1 transmission, respectively. However, if a msgB or msg2 are not received at the end of the RAR window, the WTRU may still consider the successful, possibly only if the preamble was selected from a certain PRACH partition or resource subset. For a 2-step tracing RA, the WTRU may be predefined to always monitor for msgB or RAR, but consider the procedure successful if the WTRU received neither.

### Tracing Random Access Procedure—Tracing RA, an RA Initiated for Reporting to a Camped Cell: Indication of Alternative Cells by Preamble Partitioning

A WTRU may be configured with one or more PRACH resources or preamble partitions, whereby the WTRU selects a preamble from a given partition in a tracing RA based on at least one of the following, herein referred to “tracing indication conditions”:
a) whether there is at least N alternative or neighbor cell with channel conditions measured above a threshold (or below another threshold), where N=>1. For example, the WTRU may be configured with a partition to select only if at least N alternative neighbor cells were measured with a channel condition above a threshold.
b) if there are no alternative cells with channel conditions measured above a threshold (or below another threshold). For example, the WTRU may be configured with a partition to select only if there are no alternative neighbor cells with measured with a channel condition above a threshold.
c) the cell index measured with channel conditions above a threshold. The WTRU may be configured with a preamble partition per alternative or neighbor cell, the WTRU may then select a preamble to indicate the alternative cell that was measured with the best channel conditions to the WTRU. For example, the WTRU may receive a configuration part broadcast signaling for PRACH partition for each neighbor cell to the broadcasting cell.
d) whether the probed cell is measured with channels conditions within a range, above, or below threshold; where the probed cell is the cell from which network tracing probe indication was received (as described in section ‘Triggers to Initiate Special RA for Camped Cell Reporting’ further on in this document) or the cell that is indicated in a network tracing probe indication. The threshold may be indicated part of the network tracing probe indication, as described in section ‘Camped Cell Quality-Based Trigger’ further on in this document. For example, the WTRU may be configured with a partition to select only if the probed cell is measured with a channel condition above or below a threshold.
e) whether the camped cell (the cell on which the WTRU has camped) is measured with channels conditions within a range, above, or below threshold.
f) whether the WTRU's location is within a certain range or within a certain max distance from the probed cell or the reference location coordinates indicated part of the tracing probe indication; where the probed cell is the cell from which network tracing probe indication was received (as described in section ‘Location-based Trigger’ further on in this document) or the cell that is indicated in a network tracing probe indication. For example, the WTRU may be configured with a partition to select only if the WTRU location is within a max distance (which can be indicated in the tracing probe indication) from the probed cell location or a reference location indicated part of the tracing probe indication, and a different partition otherwise.
   Tracing Random Access Procedure—Tracing RA, an RA Initiated for Reporting to a Camped Cell: Indication of Alternative Cells in msgA Payload or Msg3 Payload

For a tracing RA, the WTRU may include at least one of the following info part of the payload of msg3 or msgA:
a) whether there is at least N alternative cell with channel conditions measured above a threshold (or below another threshold), where N=>1.
b) whether there are no alternative cells with channel conditions measured above a threshold (or below another threshold).
c) whether an alternative cell or a probed cell is measured with a channel condition above or below a threshold.
d) the alternative cell index (or indices) measured with channel conditions above a threshold.
e) a measurement of a channel condition associated with the camped cell, the probed cell, or an indicated alternative cell. WTRU may indicate in msg3 or msgA whether the camped cell or the probed cell is measured with channels conditions within a range, above, or below threshold. For example, the WTRU may include a Srxlev, Squal, Qrxlevmeas, Qqualmeas measurement associated with the camped cell, an alternative cell, or a probed cell.
f) the WTRU location or position, and/or whether the WTRU's location is within a certain range or within a certain max distance from the probed cell or the reference location coordinates indicated part of the tracing probe indication (as explained in section ‘Location-Based Trigger’ further on in the present document).
g) the frequency or the RAT on which the WTRU is camped.

Such information can be indicated by the WTRU in an RRC message or a MAC CE multiplexed in msg3 or msgA. The WTRU may include such information only if the tracing RA is not RAR-less for a 4-step RA. The WTRU may include such information only if the tracing probing indication included information on an alternative cell, the WTRU may include such information only if one or more of the tracing indication conditions are satisfied.

The thresholds mentioned herein may be predefined, configured (e.g., part of broadcast signaling), or indicated part of the tracing probe indication.

### Tracing Random Access Procedure—Tracing RA, an RA Initiated for Reporting to a Camped Cell: Preamble TX Time—Random Backoff Prior to Preamble Transmission in a Tracing RA

The WTRU may apply a backoff value prior to transmitting a preamble and/or msgA payload for an initiated tracing RA procedure. The backoff start time can be related to the instance at which the procedure is initiated (e.g., the time at which the WTRU received the tracing probe command/indication, or the instance at which the WTRU determines from neighbor cell measurements to trigger the tracing RA). The backoff value can be chosen at random by the WTRU between 0 and a max backoff value configured or predetermined (e.g., the max backoff value prior to preamble retransmission can be reused), where the selected value is according to an outcome of a uniform distribution between 0 and the max backoff value. The WTRU may determine the backoff value from the WTRU identity. The WTRU may determine the max backoff value from the WTRU identity.

According to an embodiment, the WTRU may start a timer from upon initiating a tracing RA procedure or meeting any of the triggers in further section ‘Triggers to Initiate Special RA for Camped Cell Reporting’. The WTRU may transmit a preamble and/or other RA messages while such timer is running. After the expiry of the timer, the WTRU refrains from transmitting preambles or other RA messages, and stop monitoring PDCCH for reception of any RA messages (e.g., msg2, msg4, msgB). The WTRU may be configured or predefined with a maximum number of preamble transmissions to apply for a tracing RA procedure. The WTRU may apply a differentiated power ramping step or a backoff value between preamble retransmissions for a tracing RA procedure, compared to values used for initial access RA.

### Tracing Random Access Procedure—Tracing RA, an RA Initiated for Reporting to a Camped Cell: Cell Re-Selection Upon NES Indication and UL Indication to the Network Over the Re-Selected Cell

A WTRU may have information related to stable cells. These cells may be the coverage providing macro cells which stay ON and do not apply NES. The WTRU can be provided with the information related to stable cells as part of the network configuration, or this configuration can be part of the system information or an attribute of the signal from the cell.

In one solution, when the WTRU detects the current camped cell turning OFF, the WTRU will re-select to one of the suitable cells. The WTRU provides an indication to the network about the cell re-selection triggered by NES indication and former camped cell turning off, through a special RACH access as proposed earlier. This indication can be configured to be transmitted if the WTRU re-selects to a cell with the same tracking area for RRC_IDLE or with the same RAN notification area for RRC_INACTIVE.

According to an embodiment, the WTRU indication following the cell-reselection can be limited for the case when it re-selects to a non-stable cell. Upon performing cell re-selection, possibly conditioned on having the reselected cell configured as non-stable cell, the WTRU may trigger a tracing RA and/or indicate that it has performed cell reselection and is camping on a non-stable cell. Such can be included e.g., part of a MAC CE or an RRC message, possibly indicating the cell index of the new camped cell. This allows the network to track the WTRUs which are camping on the non-stable cells and it can take precautionary measures prior to turning such cells OFF.

### Triggers to Initiate Special RA for Camped Cell Reporting

### Triggers to Initiate Special RA for Camped Cell Reporting—Triggering by Tracing Probe Command

In a first step, a network may send a camping-probe request (e.g., group paging, an indication in the paging payload/short message, or SIB broadcast, etc.).

In a second step, IDLE/INACTIVE WTRUs camping under that cell from which the camping-probe was received respond informing the NW they are camping on the cell; these WTRUs initiate a tracing RA as described in preceding section ‘Tracing Random Access Procedure’.

Upon reception of a tracing probe command/indication, the WTRU may trigger/initiate a tracing RA procedure, as described in in previous sections, and/or report its camped cell. The WTRU may receive a tracing probe command/indication by reception of at least one of the following:
probing command in paging;
probing by broadcast signalling, SIB update, or SI reception;
probing command by PDCCH reception;
probing by MT6SDT or PDSCH reception (MAC CE or RRC message)
As detailed in the following sections.

### Triggers to Initiate Special RA for Camped Cell Reporting—Triggering by Tracing Probe Command: Probing Command in Paging

The WTRU may receive a tracing probe indication in the form of reception of—or part of—a paging message, paging DCI, paging PDSCH, or a paging related signal (e.g. PEI), possibly on a subset of Paging occasions, paging frames, or a subset of PCCH paging occasions within a PO (e.g. those aligned with NES drx cycle or a configured subset of PDCCH resources). The WTRU may trigger a tracing RA—or determine that a tracing probe is received-upon reception of a indication part of the DCI or PDCCH scheduling paging (e.g. as a function of the P-RNTI, NES-RNTI or based on receiving an explicit indication—e.g. on a reserved bit). The WTRU may trigger a tracing RA—or determine that a tracing probe is received-upon reception of a paging message with a certain P-RNTI, a separately configured NES P-RNTI, or the NES group RNTI. The WTRU may be configured with one more PEI subgroup for NES or for reception of a tracing probe command, where a subgroup may be associated with reception of a tracing probe command or indication. The WTRU may trigger a tracing RA—or determine that a tracing probe is received-upon reception of a PEI with an NES subgroup or tracing probe subgroup, possibly if that subgroup is configured and/or associated with WTRU tracing probe. The WTRU tracing probe command may be indicated in the paging payload, e.g. as a flag part of the paging message, the paging PDSCH, or the part of the short message. The WTRU tracing probe command may be indicated part of the PDCCH scheduling the paging message. Such paging indication may further indicate an alternative cell to measure while the cell from which the signaling was received is off, sleep, or in NES state.

### Triggers to Initiate Special RA for Camped Cell Reporting—Triggering by Tracing Probe Command: Probing by Broadcast Signaling, SIB Update, or SI Reception

A WTRU may receive a tracing probe command part of reception of broadcast signaling, possibly in SIB(s) associated with NES state indication or change. The WTRU may be configured with one or more SIBs exclusively associated with reception of tracing probe command and/or tracing RA parameters. The WTRU may monitor or read SIB(s) associated with a tracing probe command if there is a SI update and/or during a subset of SI modifcation periods. The WTRU may be configured to receive such broadcast or multicast indication periodically; The WTRU may start inter-cell, inter-frequency, and/or inter-RAT measurements, or start a cell re-selection procedure following the reception of a tracing probe command or after a misdetection of an expected periodic tracing probe indication.

### Triggers to Initiate Special RA for Camped Cell Reporting—Triggering by Tracing Probe Command: Probing Command by PDCCH Reception

In Inactive state, the WTRU may monitor a tracing probe indication on PDCCH addressed to the WTRU's C-RNTI or I-RNTI. The WTRU may determine the indication as a property of DCI or an indication by DCI, including an explicit indication by a DCI field or by RNTI used to mask CRC of the PDCCH, or an implicit indication by a property such as DCI format, DCI size, Coreset or search space, aggregation level, or the identity of first control channel resource for a DCI.

### Triggers to Initiate Special RA for Camped Cell Reporting—Triggering by Tracing Probe Command: Probing by MT-SDT or PDSCH Reception (MAC CE or RRC Message)

In Inactive state, a WTRU may receive a tracing probe command part of the paging message triggering the MT-SDT procedure. The WTRU may include any of the contents listed above part of msg3 in the SDT payload (e.g., part of PDU containing SDT data, on a RA-SDT resource, a CG-SDT resource, or a any UL resource of a tracing RA procedure), possibly along with an RRC resume message. The WTRU may transmit an RRC resume with a different or a specific resume cause, depending on whether of any of—or a combination of—the aforementioned tracing indication conditions is met or not. The WTRU may determine whether to transmit an RRC resume message or not depending on whether of any of—or a combination of—the aforementioned tracing indication conditions is met.

The WTRU may receive a tracing probe command/indication part of a PDSCH payload (e.g. part of a DL SDT payload or a paging PDSCH) and/or part of a DL MAC CE multiplexed on the PDSCH. The MAC CE may indicate further one or more alternative cells. The MAC CE may further indicate a threshold for measurements of channel conditions for cells to be deemed acceptable for camping and/or cell selection. The MAC CE may further indicate a measurement resource, a measurement object, and/or an SSB or CSI-RS to measure and related configurations, from the camped cell or a from a different cell (e.g., a neighbor cell or an alternative cell). Such info in the MAC CE can be alternatively indicated part of a DL RRC message (e.g., a dedicated RRC message).

### Triggers to Initiate Special RA for Camped Cell Reporting—Location-Based Trigger

In a first step, a network may send a camping-probe request.

A WTRU may be configured with a list alternative/stable cells.

The camping-probe request may include:
a) a reference location info or range (e.g., coordinates of the gNB, co-ordinate range), and/or
b) an indication that the serving cell is about to turn off or apply NES.

In a second step, if the WTRU is within a certain radius from the indicated reference location, the WTRU may respond with a tracing RA on the probing cell as described in previous section ‘Triggering by Tracing Probe Command’.

According to an embodiment, the WTRU may initiate a tracing RA and/or report its location or its camped cell upon reception of a location based a tracing probe command. A location-based tracing probe command can be received by any of the methods described in previous section ‘Triggering by Tracing Probe Command’. A tracing probe command may include at least one of the following:
a) a reference location: the command may include coordinates of a reference location to be used by the WTRU to report its location, camped cell or initiate a tracing RA, if the WTRU is within a max distance from such reference location;
b) a flag indicating that this a location-based tracing probe command. Upon reception of such command with such flag raised (e.g., as a Boolean “1”), the WTRU may report its location, its camped cell, or initiate a tracing RA if the WTRU is within a max distance from the cell coordinates or the indicated reference location-if any-. The WTRU may know priori the locations of a selection of cells in the network, in which case the reference location may not be needed/indicated part of the command. Such can be determined based on whether the WTRU knows the location of the camped cell à priori;
c) a maximum distance. The WTRU reports its location, computed cell, or initiates a tracing RA if it is within the indicated max distance from the reference location or the coordinates of the probing cell;
d) a cell identity or index. The WTRU reports its location, computed cell, or initiates a tracing RA if it is within the indicated max distance from the indicated cell ID;
e) configuration of positioning related parameters to use, e.g., in connected mode (e.g. after the WTRU initiates a tracing RA);
f) an indication that the serving cell is about to turn off or apply a NES technique (e.g., cell DTX/DRX, spatial or power domain coverage reduction/adaptation, etc.) possibly within a certain time period;
g) a time duration associated with the reporting period. The WTRU may start a timer upon or after the reception of the camping probe. The WTRU may report its position, camped cell, or initiate a tracing RA only while such timer is running.

### Triggers to Initiate Special RA for Camped Cell Reporting—Camped Cell Quality Based Trigger

In a first step, a network may send a camping-probe request (i.e., a network node may send camping-probe request to discover WTRUs that are camped on a cell).

WTRUs may be configured with a list of alternative/stable cells.

The camping-probe request may include:
a) a reference signal/SSB to measure, possibly from the same cell or a neighbor cell, or
b) an instruction to measure SSBs/RS of the cell from which the camping-probe request was received, or
c) an indicated/configured alternative cell, or an indication that the serving cell is about to turn off or apply NES.

In a second step, if the WTRU is within a certain radius from the indicated reference location, or if the WTRU measures the cell from which the camping-probe request was received within a certain signal strength/quality (above an indicated threshold), or if the WTRUs that measure a neighbor/alternative cell within a certain signal strength/quality: WTRU responds with a special RA on the probing cell (the cell from which the camping-probe request was transmitted) as described in previous section ‘Triggering by Tracing Probe Command’.

According to an embodiment, the WTRU may initiate a tracing RA and/or report its location or its camped cell upon reception of a cell quality-based a tracing probe command. A cell quality-based tracing probe command can be received by any of the means described in previous section ‘Triggering by Tracing Probe Command’. A tracing probe command may include at least one of the following:
a) a flag indicating that this a cell quality-based tracing probe command. Upon reception of such command with such flag raised (e.g., as a Boolean “1”), the WTRU may report cell measurements (e.g., including the camped cell, alternative cell(s), stable cell(s), or a subset of neighboring cells meeting a quality threshold). The WTRU may further report its camped cell and/or initiate a tracing RA if the WTRU makes a channel condition measurement associated with the camped cell with a value above a predetermined, configured, or indicated threshold;
b) a signal strength or cell quality threshold, the WTRU may report cell measurements, its camped cell and/or initiate a tracing RA if the WTRU makes a channel condition measurement associated with {the probing cell, the camped cell, or an indicated neighbor cell within the command} with a value above or below a predetermined, configured, or indicated threshold;
c) a cell identity or index on which the WTRU is expected to perform channel condition measurements and report cell measurements, its camped cell, and/or initiate a tracing RA if the WTRU measurement associated with the indicated cell is below or above the threshold.

The WTRU reports its location, computed cell, or initiates a tracing RA if it is within the indicated max distance from the indicated cell ID;
d) configuration of measured related parameters to use (e.g., a measurement object);
e) a reference signal/SSB to measure, possibly from the same probing cell or a neighbor cell. if the WTRU is camped on an SSB-less cell, the WTRU may be indicated with a different carrier from which the WTRU may measure channel conditions;
f) a frequency band or carrier or bandwidth part on which the WTRU is expected to perform channel measurements;
g) an instruction to measure SSBs/RS of the cell from which the probe was received or an indicated/configured alternative cell;
h) an indication that the serving cell is about to turn off or apply a NES technique (e.g., cell DTX/DRX, spatial or power domain coverage reduction/adaptation, etc.) possibly within a certain time period;
i) a time duration associated with the reporting period. The WTRU may start a timer upon or after the reception of the camping probe. The WTRU may report measurements, associated cell indices, camped cell, and/or initiate a tracing RA only while such timer is running.

If the WTRU measures the camped cell, the probing cell, and/or a neighbor/alternative cell within a certain signal strength/quality (e.g., with measured channel condition(s) above a threshold), the WTRU may respond to the tracing probe command with a tracing RA on the probing cell as described in previous section ‘Triggering by Tracing Probe Command’.

If the WTRU does not find any cell (possibly only from the list of alternative or stable cells) that meets a given quality threshold (e.g., with measured channel condition(s) above a threshold), the WTRU may indicate such state part of the tracing RA or any UL transmission.

### Triggers to Initiate Special RA for Camped Cell Reporting—WTRU Autonomous Trigger Based on Neighbor Cell Measurements

In a first step, a WTRU receives an indication/configuration or determines that the camped cell is an NES cell, a cell that may be turned off, or is applying a NES state.

The WTRU may be configured with a list alternative/stable cells.

In a second step, the WTRU may measure the camped cells and other neighbor cells, possibly only for a limited period.

If at least one of the following is satisfied:
a) the {Srxlev, Squal, Qrxlevmeas, and/or Qqualmeas} of the camped cell is above a threshold and/or less than a second threshold;
b) the {Srxlev, Squal, Qrxlevmeas, and/or Qqualmeas} of a neighbor/alternative cell is measured above a threshold and/or less than a second threshold;
c) there are no good alternative cells above a threshold, e.g., based on {Srxlev, Squal, Qrxlevmeas, and/or Qqualmeas} of the neighbor cells;
d) an alternative cell becomes above a threshold after having no good alternative cell.

Then, in a third step, the WTRU autonomously reports to the NW if other cells are not suitable, or the camped cell can turn off/apply NES (e.g., initiate a special RA on the camped cell): the WTRU responds with a RA on the camped cell as in previous section ‘Network Probed Identification of Camped WTRUs’. One or more of the above conditions a-d may result in this behaviour.

This (the above) embodiment proposes a solution where network is putting (at least) one of the cells in energy saving state (e.g., turning OFF completely). This will require that the WTRUs camped on this cell find an alternative cell to camp on. Upon determining that the camped cell is going to turn OFF, whether through an explicit NES indication or through pre-configuration, WTRU will make measurements on the camped cell and neighbor cells. If any of the neighbor cells can be a suitable candidate, the WTRU performs cell re-selection to the neighbor cell satisfying the NES cell-reselection criterion. NES cell-reselection criterion does not consider the measurement quality over the current camped cell as it is going to be turned OFF by the network. This can be achieved either by configuring suitable offsets, or just by ignoring the cell re-selection conditions over the currently camped cell.

If the currently camped cell is going to be turned OFF, and none of the neighbor cell satisfies the suitability criterion, the WTRU will trigger a random access procedure on the currently camped cell. This informs the network that the WTRU launching the random access will have issues when the current cell turns OFF. Upon receiving this information, the network can take appropriate action. The network can postpone turning OFF the current cell, or can indicate another potential target (intra-/inter-) cell for the WTRU to camp on.

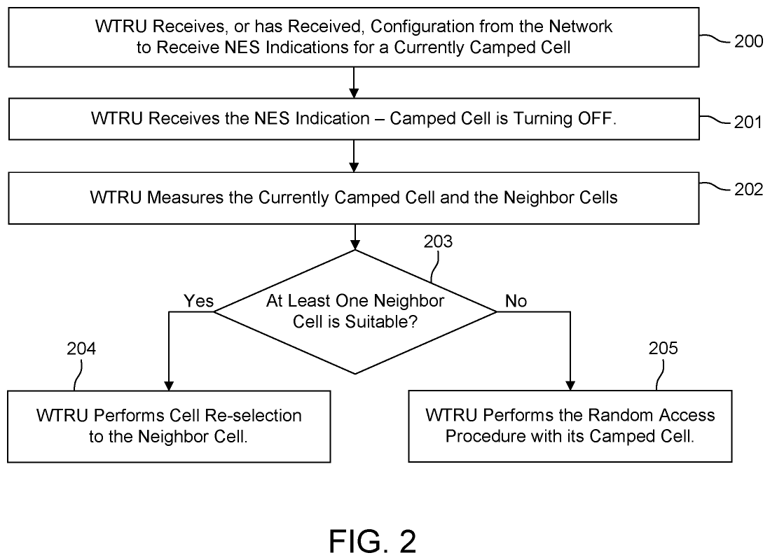

FIG. 2 is a flow chart of a method for a WTRU according to this embodiment.

In 200, the WTRU is (pre-) configured that the camped cell is an NES cell, a cell that may be turned off, or is applying a NES state. The WTRU has been configured to receive NES indication from the camped cell.

The WTRU may be configured with a list of alternative/stable cells (step not shown).

In 201, the WTRU receives the indication (‘NES indication’) from the camped cell about the cell being tuned OFF after a configured/indicated duration. The indication may be an explicit indication as described in section ‘Network-Probed Identification of Camped WTRUs’, or the indication may be known to the WTRU through pre-configuration, or the indication may be a pattern (e.g., a periodic ON/OFF sleep pattern) provided to the WTRU through system information broadcast or the indication may be pre-configured.

In 202, the WTRU measures the camped cells and other neighbor cells, possibly only for a limited measurement period.

If one or more of the following criteria are satisfied:
a) the {Srxlev, Squal, Qrxlevmeas, Qqualmeas} of the camped cell is above a first set of thresholds and/or less than a second set of thresholds;
b) the {Srxlev, Squal, Qrxlevmeas, Qqualmeas} of the list of neighbor/alternative cells is measured above a first set of thresholds and/or less than a second set of thresholds;
Then (203—Yes), the WTRU selects one of the neighbor cells satisfying any of the two criteria or both, and the WTRU performs, 204, cell re-selection to the selected neighbor cell.

Else, in 205, the WTRU autonomously reports to the NW (e.g., initiate a special RA on the camped cell) that none of the other cells are suitable, and the WTRU responds with a RA on the camped cell as described in section ‘Network-Probed Identification of Camped WTRUs’.

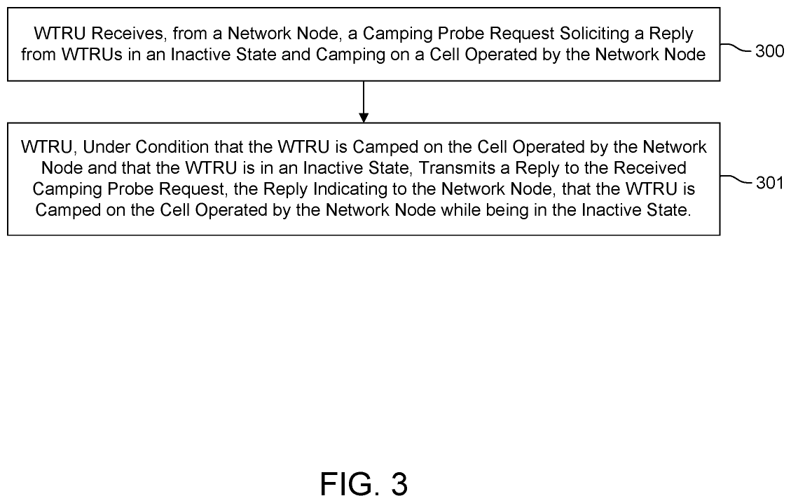

FIG. 3 is a flow chart of a method according to an embodiment.

In 300, the WTRU receives, from a network node, a camping probe request soliciting a reply from WTRUs in an inactive state and camping on a cell operated by the network node.

In 301, the WTRU, under condition that the WTRU is camped on the cell operated by the network node and that the WTRU is in an inactive state (e.g., in one or more of (RRC) idle, (RRC_)inactive states or modes), transmits a reply to the received camping probe request. The reply indicating to the network node, that the WTRU is camped on the cell operated by the network node while being in the inactive state.

According to an embodiment of the method, the reply is a random access channel request comprising an indication to the network node that the random access channel request is transmitted in reply to the camping probe request.

According to an embodiment of the method, the reply comprises an indication to the network node whether the WTRU reselects an alternative cell.

According to an embodiment of the method, the method comprises
a) reception of configuration information comprising a list of alternative cells;
b) reselecting a cell from the list of alternative cells.

According to an embodiment of the method, the camping probe request is one of:
a) a group paging indicating a camping probe request;
b) a system information block broadcast, SIB, indicating a camping probe request.

According to an embodiment of the method, the camping probing request comprises at least one of:
a) information related to a reference location of the network node;
b) information related to a reference signal to measure from the cell operated by the network node;
c) information related to a reference signal or synchronization signal block, SSB, to measure from a neighbor cell of the cell operated by the network node;
d) information enabling the WTRU to measure a reference signal or a synchronization block of the cell operated by the network node;
e) information enabling the WTRU to measure a reference signal or a synchronization block of a neighbor cell of the cell operated by the network node.

According to an embodiment of the method, the reply to the camping probe request is transmitted under at least one of the following conditions:
a) the WTRU is within a predefined radius from the reference location of the network node;
b) the reference signal or SSB of the cell operated by the network node, as measured at the WTRU is above a threshold;
c) the reference signal or SSB of the neighbor cell of the cell operated by the network node is above a threshold.

There is also described and disclosed a WTRU, comprising at least one processor. The at least one processor is configured:
to receive, from a network node, a camping probe request soliciting a reply from WTRUs in an inactive state and camping on a cell operated by the network node; and
under condition that the WTRU is camped on the cell operated by the network node and that the WTRU is in an inactive state, to transmit a reply to the received camping probe request, the reply indicating to the network node, that the WTRU is camped on the cell operated by the network node while being in the inactive state.

According to an embodiment of the WTRU, the at least one processor is configured to transmit the reply in a form of a random access channel request comprising an indication to the network node that the random access channel request is transmitted in reply to the camping probe request.

According to an embodiment of the WTRU, the at least one processor is configured to include, in the reply, an indication to the network node whether the WTRU reselects an alternative cell.

According to an embodiment of the WTRU, the at least one processor is configured to:
receive configuration information comprising a list of alternative cells;
reselect a cell from the list of alternative cells.

According to an embodiment of the WTRU, the at least one processor is configured to receive the camping probe request in a form of at least one of:
a group paging indicating a camping probe request;
a system information block broadcast, SIB, indicating a camping probe request.

According to an embodiment of the WTRU, the at least one processor is configured to receive the camping probing request comprising at least one of:
information related to a reference location of the network node;
information related to a reference signal to measure from the cell operated by the network node;
information related to a reference signal or synchronization signal block, SSB, to measure from a neighbor cell of the cell operated by the network node;
information enabling the WTRU to measure a reference signal or a synchronization block of the cell operated by the network node;
information enabling the WTRU to measure a reference signal or a synchronization block of a neighbor cell of the cell operated by the network node.

According to an embodiment of the WTRU, the at least one processor is configured to transmit the reply to the camping probe request under at least one of the following conditions:
the WTRU is within a predefined radius from the reference location of the network node;
the reference signal or SSB of the cell operated by the network node, as measured at the WTRU is above a threshold;
the reference signal or SSB of the neighbor cell of the cell operated by the network node is above a threshold.

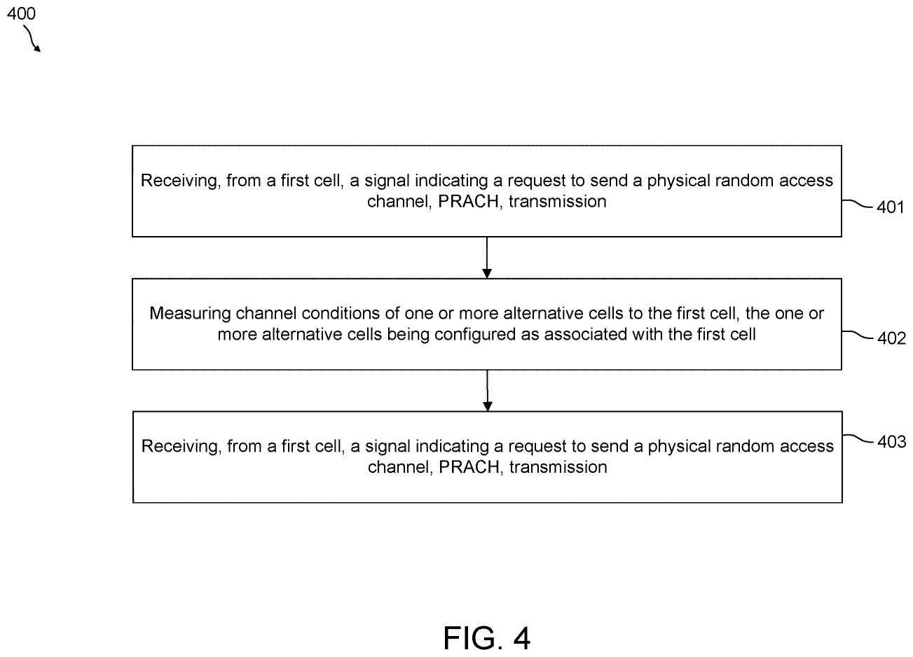

FIG. 4 is a method 400 according to an embodiment. The method is implemented by a wireless transmit-receive unit, WTRU. The method may comprise:
In 401, receiving, from a first cell, a signal indicating a request (e.g., a camping-probe request) to send a physical random access channel, PRACH, transmission;
In 402, measuring channel conditions of one or more alternative cells to the first cell, the one or more alternative cells being configured as associated with the first cell; and
In 403, sending to the first cell a PRACH transmission, wherein the PRACH transmission indicates a preamble from either a first preamble partition (e.g., a preamble partition A) or a second preamble partition (e.g., a preamble partition B).

According to an embodiment of the method, the WTRU may select the first or the second preamble partition based on one of the following measured channel conditions:
a) no alternative cell of the one or more alternative cells having at least one of the measured channel conditions above a threshold (i.e., there are no good alternative cells);
b) at least one alternative cell of the one or more alternative cells having at least one of the measured channel conditions above a threshold (i.e., there is at least one good enough alternative cell);
c) at least one of the measured channel conditions of the first cell are within a threshold (i.e., the probed cell is within a strength threshold);
d) at least one of the measured channel conditions of the first cell are less than a threshold (i.e., the probed cell is measured less than a threshold).

According to an embodiment of the method, the method comprises transmitting (e.g. in an RRC message or a MAC CE), to the first cell, an indication of the measured channel conditions that led to the selecting of the first or the second preamble partition.

According to an embodiment of the method, the method comprises receiving configuration information comprising the one or more alternative cells and PRACH preambles associated with the alternative cells.

According to an embodiment of the method, the request is one of:
a) a group paging;
b) an indication in a paging payload or short message;
c) a system information block, SIB, broadcast.

According to an embodiment of the method, the method comprises transmitting, to the first cell, an indication of an identity of the at least one alternative cell of the one or more alternative cells having at least one of the measured channel conditions above a threshold.

According to an embodiment of the method, the indication is multiplexed in a physical uplink shared channel, PUSCH, transmission.

There is also disclosed a wireless transmit-receive unit, WTRU, the WTRU comprising at least one processor. The at least one processor is configured to:

receive, from a first cell, a signal indicating a request (e.g., a camping-probe request) to send a physical random access channel, PRACH, transmission;
measure channel conditions of one or more alternative cells to the first cell, the one or more alternative cells being configured as associated with the first cell; and
send to the first cell a PRACH transmission, wherein the PRACH transmission indicates a preamble from either a first preamble partition (e.g., a preamble partition A) or a second preamble partition (e.g., a preamble partition B).

According to an embodiment of the WTRU, the at least one processor is configured to select the first or the second preamble partition based on one of the following measured channel conditions:
a) no alternative cell of the one or more alternative cells having at least one of the measured channel conditions above a threshold (i.e., there are no good alternative cells);
b) at least one alternative cell of the one or more alternative cells having at least one of the measured channel conditions above a threshold (i.e., there is at least one good enough alternative cell);
c) at least one of the measured channel conditions of the first cell are within a threshold (i.e., the probed cell is within a strength threshold);
d) at least one of the measured channel conditions of the first cell are less than a threshold (i.e., the probed cell is measured less than a threshold).

According to an embodiment of the WTRU, the at least one processor is configured to transmit (e.g. in an RRC message or a MAC CE), to the first cell, an indication of the measured channel conditions that led to selection of the first or the second preamble partition.

According to an embodiment of the WTRU, the at least one processor is configured to receive configuration information comprising the one or more alternative cells and PRACH preambles associated with the alternative cells.

According to an embodiment of the WTRU, the request is one of: a group paging; an indication in a paging payload or short message; a system information block, SIB, broadcast.

According to an embodiment of the WTRU, the at least one processor is configured to transmit, to the first cell, an indication of an identity of the at least one alternative cell of the one or more alternative cells having at least one of the measured channel conditions above a threshold.

According to an embodiment of the WTRU, the at least one processor is configured to multiplex the indication a physical uplink shared channel, PUSCH, transmission.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, implemented by a wireless transmit-receive unit, WTRU, the method comprising:
receiving, from a first cell, a signal indicating a request to send a physical random access channel, PRACH, transmission;
measuring channel conditions of one or more alternative cells to the first cell, the one or more alternative cells being configured as associated with the first cell;
selecting a first preamble partition or a second preamble partition, the first preamble partition and the second preamble partition indicating an identity of at least one of the one or more alternative cells, based on the measured channel conditions; and
sending to the first cell a PRACH transmission, wherein the PRACH transmission indicates a preamble from either the first preamble partition or the second preamble partition.

2. The method according to claim 1, wherein selecting the first or the second preamble partition comprises selecting:
the first preamble partition if no alternative cell of the one or more alternative cells having at least one of the measured channel conditions above a threshold;
the second preamble partition if at least one alternative cell of the one or more alternative cells having at least one of the measured channel conditions above a threshold;
the second preamble partition if at least one of the measured channel conditions of the first cell are within a threshold; or
the first preamble partition if at least one of the measured channel conditions of the first cell are less than a threshold.

3. The method according to claim 2, comprising transmitting, to the first cell, an indication of the measured channel conditions that led to selecting first preamble partition or the second preamble partition.

4. The method according to claim 1, comprising receiving configuration information comprising the one or more alternative cells and PRACH preambles associated with the alternative cells.

5. The method according to claim 1, wherein the request is one of:
a group paging;
an indication in a paging payload or short message; and
a system information block, SIB, broadcast.

6. The method according to claim 2, comprising transmitting, to the first cell, an indication of an identity of the at least one alternative cell of the one or more alternative cells having at least one of the measured channel conditions above a threshold.

7. The method according to claim 6, wherein the indication is multiplexed in a physical uplink shared channel, PUSCH, transmission.

8. A wireless transmit-receive unit, WTRU, comprising at least one processor, wherein the at least one processor is configured to:
receive, from a first cell, a signal indicating a request to send a physical random access channel, PRACH, transmission;
measure channel conditions of one or more alternative cells to the first cell, the one or more alternative cells being configured as associated with the first cell;
select a first preamble partition or a second preamble partition, the first preamble partition and the second preamble partition indicating an identity of at least one of the one or more alternative cells, based on the measured channel conditions; and
send to the first cell a PRACH transmission, wherein the PRACH transmission indicates a preamble from either the first preamble partition or the second preamble partition.

9. The WTRU according to claim 8, wherein the at least one processor is configured to select:
the first preamble partition if no alternative cell of the one or more alternative cells having at least one of the measured channel conditions above a threshold;
the second preamble partition if at least one alternative cell of the one or more alternative cells having at least one of the measured channel conditions above a threshold;
the second preamble partition if at least one of the measured channel conditions of the first cell are within a threshold; or
the first preamble partition if at least one of the measured channel conditions of the first cell are less than a threshold.

10. The WTRU according to claim 9, wherein the at least one processor is configured to transmit, to the first cell, an indication of the measured channel conditions that led to selection of the first preamble partition or the second preamble partition.

11. The WTRU according to claim 8, wherein the at least one processor is configured to receive configuration information comprising the one or more alternative cells and PRACH preambles associated with the alternative cells.

12. The WTRU according to claim 8, wherein the request is one of:
a group paging;
an indication in a paging payload or short message; and
a system information block, SIB, broadcast.

13. The WTRU according to claim 9, wherein the at least one processor is configured to transmit, to the first cell, an indication of an identity of the at least one alternative cell of the one or more alternative cells having at least one of the measured channel conditions above a threshold.

14. The WTRU according to claim 13, wherein the at least one processor is configured to multiplex the indication a physical uplink shared channel, PUSCH, transmission.
